(19) United States
(12) Patent Application Publication
(10) Pub. No.: US 2009/0186988 A1
(43) Pub. Date: Jul. 23, 2009

(54) MODIFIED AMINOPLAST CROSSLINKERS AND COATING COMPOSITIONS CONTAINING SUCH CROSSLINKERS

(75) Inventors: Lawrence G. Anderson, Allison Park, PA (US); Shiryn Tyebjee, Allison Park, PA (US); Jane N. Valenta, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/017,563

(22) Filed: Jan. 22, 2008

(51) Int. Cl. C08F 8/34; C08G 75/02; C08G 75/00; C08G 63/91; C08G 18/00; C08G 61/02; C08F 283/01

(52) U.S. Cl. 525/351; 528/373; 528/374; 528/86; 525/535; 525/418; 525/452

(57) ABSTRACT

Disclosed are crosslinking agents that are the reaction product of reactants that include: (a) an aminoplast compound, and (b) an aminoplast-reactive functional group-containing sulfur-containing compound. Also disclosed are coating compositions and related coatings that utilize such crosslinking agents.

### FIELD OF THE INVENTION

The present invention relates to crosslinking agents based on modified aminoplast resins and to coating compositions containing such crosslinking agents.

### BACKGROUND OF THE INVENTION

Aminoplast resins are well known in the art as low cost crosslinking agents for hydroxyl, carboxyl, thiol, and/or carbamate functional polymers in coating compositions. Common aminoplast resins are based on condensation products of formaldehyde with an amino- or amido-group carrying substance. Condensation products obtained from the reaction of alcohols and formaldehyde with melamine, urea or benzoguanamine are commonly used in coating compositions where they provide enhanced coating properties such as exterior durability, chemical resistance and mar resistance. Such aminoplast resins often are in liquid form.

It would be desirable to provide novel modified aminoplast crosslinkers that, in at least some cases, improve certain properties of coatings formed from compositions including such crosslinkers, such as appearance and/or acid etch resistance. The present invention was made in view of the foregoing.

### SUMMARY OF THE INVENTION

In certain respects, the present invention is directed to a crosslinking agent comprising an ungelled reaction product of reactants comprising: (a) an aminoplast compound; and (b) an aminoplast-reactive functional group-containing sulfur-containing compound.

In other respects, the present invention is directed to coating compositions comprising (A) a polymer having functional groups reactive with aminoplast groups; and (B) the previously described crosslinking agent.

Multilayer composite coatings are also provided. The multilayer composite coatings comprise a base coat deposited from a pigmented film-forming composition and a transparent topcoat over the base coat. In certain embodiments, the topcoat is deposited from a coating composition of the present invention.

In still other respects, the present invention is directed to substrates at least partially coated with a coating deposited from a coating composition of the present invention.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As mentioned above, the crosslinking agent of the present invention comprises an ungelled reaction product of reactants comprising (or, in some cases, consisting of): (a) an aminoplast compound, and (b) an aminoplast-reactive functional group-containing sulfur-containing compound. As used herein, the term “ungelled” means that the reaction product can be dissolved in a suitable solvent or resin and has an intrinsic viscosity when so dissolved. The intrinsic viscosity of the reaction product is an indication of its molecular weight. A gelled reaction product, on the other hand, since it is of essentially infinitely high molecular weight, will have an intrinsic viscosity too high to measure.

The aminoplast compounds suitable for use in the preparation of the crosslinking agent of the present invention as the previously mentioned component (a) include, for example, those which are derived from at least one of glycoluril, aminotriazine and benzoguanamine. Such compounds include, for example, alkoxyalkyl derivatives of melamine, glycoluril, benzoguanamine, acetoguanamine, formoguanamine, spiroguanamine, and the like.

Aminoplast resins are based on the condensation products of formaldehyde with an amino- or amido-group carrying substance. Condensation products obtained from the reaction of alcohols and formaldehyde with melamine, urea or benzoguanamine are common. However, condensation products of other amines and amides can also be employed, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, glycoluril, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine and 3,4,6-tris(ethylamino)-1,3,5 triazine.

While the aldehyde employed is often formaldehyde, other similar condensation products can be prepared from other aldehydes such as acetaldehyde, crotonaldehyde, acrolein, benzaldehyde, furfural and glyoxal.

The aminoplast compounds can contain methylol or other alkylol groups, and in many instances, at least a portion of these alkylol groups are etherified by a reaction with an alcohol. Any monohydric alcohol can be employed for this purpose, including alcohols such as methanol, ethanol, propanol, butanol, pentanol, hexanol, heptanol and others, as well as, benzyl alcohol and other aromatic alcohols, cyclic alcohols such as cyclohexanol, monoethers of glycols, and halogen-substituted or other substituted alcohols, such as 3-chloropropanol and butoxyethanol. Commonly employed aminoplast resins include those substantially alkylated with methanol or butanol.

In certain embodiments of the present invention, the aminoplast compound comprises a highly alkylated, low imino aminoplast resin which has a degree of polymerization (“DP”) of less than 3.75, often less than 3.0, and, in some cases, less than 2.0. Generally, the number average degree of polymerization is defined as the average number of structural units per polymer chain (see George Odian, Principles of Polymerization, John Wiley & Sons (1991)). For purposes of the present invention, for example, a DP of 1.0 would indicate a completely monomeric triazine structure, while a DP of 2.0 indicates two triazine rings joined by a methylene or methylene-oxy bridge. It should be understood that the DP values reported herein and in the claims represent average DP values as determined by gel permeation chromatography data.

Non-limiting examples of suitable aminotriazine compounds include alkoxyalkyl aminotriazines, such as (methoxymethyl) melamine-formaldehyde resin, for example, RESIMENE® CE-7103, 745, and 747 commercially available from Solutia, Inc. and CYMEL® 202, 300, and 303; ethylated-methylated benzoguanimine-formaldehyde resin, for example CYMEL® 1123; ethylated-methylated melamine-formaldehyde resin, for example CYMEL® 1116; and methylated-butylated melamine-formaldehyde resin, for example CYMEL® 1135, 1133, 1168 commercially available from Cytec Industries, Inc and RESIMENE® 755, 757 commercially available from Solutia, Inc.

As aforementioned, in addition to the aminoplast compound (a) described above, the reactants used to form the crosslinking agent of the present invention further comprise an aminoplast-reactive functional group-containing sulfur-containing compound (b). As used herein, the term “aminoplast-reactive functional group-containing sulfur-containing compound” refers to compounds that comprise at least one sulfur atom and a reactive functional group that is reactive with aminoplasts, such as hydroxyl, carboxyl, anhydride, epoxy, thiol, phenolic, amine and/or amide functional groups. As used herein, the term “reactive” refers to a functional group that forms a covalent bond with another functional group under suitable reaction conditions.

Exemplary, but non-limiting, sulfur-containing compounds are thiols, polythiols, thioethers, polythioethers, and polysulfides. A “thiol”, as used herein, refers to a compound comprising a thiol (or mercaptan) group, that is, an “SH” group, either as the sole functional group or in combination with other functional groups, such as hydroxyl groups, as is the case with, for example, thioglycerols. A “polythiol” refers to such a compound having more than one “SH” group, such as a dithiol or higher functionality thiol. Such groups are often terminal and/or pendant such that they have an active hydrogen that is reactive with other functional groups.

In certain embodiments, the aminoplast-reactive functional group-containing sulfur-containing compound comprises an aminoplast-reactive functional group-containing thioether, such as a thiol functional polythioether, including polythiol polythioethers. As used herein, the terms “thioether” or “polythioether” refer to compounds that contain one or more sulfur atoms that do not contain an active hydrogen group; that is, they are bonded on either side to another sulfur atom, a carbon atom, and the like, i.e., (—S— or (—S—S—)). As used herein, the term “polysulfide” refers to any compound that comprises a sulfur-sulfur linkage (—S—S—).

In certain embodiments, the crosslinking agent of the present invention is formed by reacting (>n) moles of one or more compounds having the formula (I):

HS—R¹—SH (I)

with (n) moles of one or more compounds having the formula:

—ROCH═CH₂ (II)

in the presence of a catalyst.

In formula (I), R¹ is a C₂₋₁₀ n-alkylene group, such as a C₂₋₆ n-alkylene group; a C₂₋₆ branched alkylene group, such as a C₃₋₆ branched alkylene group having one or more pendant groups which can be, for example, alkyl groups, such as methyl or ethyl groups; an alkyleneoxy group; a C₆₋₈ cycloalkylene group; a C₆₋₁₀ alkylcycloalkylene group; a heterocyclic group; or —[(—CHR³—)ₛ—X—]_{q}—(—CHR³)ᵣ—, wherein s is an integer having a value ranging from 2 to 6, q is an integer having a value ranging from 1 to 5, r is an integer having a value ranging from 2 to 10, R³ is hydrogen or methyl, and X denotes O, S, or —NR₂—, wherein R denotes an alkyl group.

In formula (II), R is a divalent hydrocarbon radical having from 2 to 20 carbon atoms, wherein the hydrocarbon radical does not include any functional groups reactive with —SH, such as epoxy groups and ethylenically unsaturated groups. This method affords a thiol functional polythioether.

The compounds of formula (I) are dithiol compounds. Suitable dithiols include, for example, those compounds in which R¹ is a C₂₋₆ n-alkylene group, i.e., 1,2-ethanedithiol, 1,3-propanedithiol, 1,4-butanedithiol, 1,5-pentanedithiol or 1,6-hexanedithiol.

Additional suitable dithiols include, for example, those compounds in which R¹ in formula (I) is a C₃₋₆ branched alkylene group, having one or more pendent groups which can be, for example, methyl or ethyl groups. Suitable compounds having a branched alkylene group include, for example, 1,2-propanedithiol, 1,3-butanedithiol, 2,3-butanedithiol, 1,3-pentanedithiol and 1,3-dithio-3-methylbutane. Other useful dithiols include those in which R¹ in formula (I) is a C₆₋₈ cycloalkylene or C₆₋₁₀ alkylcycloalkylene group, for example, dipentenedimercaptan and ethylcyclohexyldithiol (ECHDT).

Further suitable dithiols include those in which R¹ in formula (I) is represented by the formula —[(—CHR³—)ₛ—X—]_{q}—(—CHR³)ᵣ— in which X is a heteroatom such as O, S or another bivalent heteroatom radical; a secondary or tertiary amine group, i.e., —NR⁶—, where R⁶ is hydrogen or methyl; or another substituted trivalent heteroatom. In certain embodiments, X is O or S, and thus R¹ is —[(—CH₂—)ₚ—O—]_{q}—(—CH₂—)ᵣ— or —[(—CH₂—)ₚ—S—]_{q}—(—CH₂—)ᵣ—. In certain embodiments, the indices p and r are equal, and, in some cases, both have the value of 2. Exemplary dithiols of this type include dimercaptodiethylsulfide (DMDS) (p, r=2, q=1, X═S); dimercaptodioxaoctane (DMDO) (p, q, r=2, X=0); and 1,5-dithia-3-oxapentane. It is also possible to employ dithiols that include both heteroatom substituents in the carbon backbone and pendent alkyl, in particular methyl, groups. Such compounds include methyl-substituted DMDS, such as HS—CH₂CH(CH₃)—S—CH₂CH₂—SH, HS—CH(CH₃)CH₂—S—CH₂ CH₂—SH and dimethyl substituted DMDS such as HS—CH₂CH(CH₃)—S—CH(CH₃)CH₂—SH and HS—CH(CH₃)CH₂—S—CH₂CH(CH₃)—SH.

Two or more different dithiols of formula (I) can also be employed if desired in preparing polythioethers suitable for use in the present invention.

The compounds of formula (II) are vinyl ethers. Specific examples of suitable vinyl ethers include, without limitation, ethyl vinyl ether, propyl vinyl ether, butyl vinyl ether, isobutyl vinyl ether, dodecyl vinyl ether, octadecyl vinyl ether, ethylene glycol monovinyl ether, butanediol monovinyl ether, ethylene glycol butyl vinyl ether, triethylene glycol methyl vinyl ether, 2-ethylhexyl vinyl ether, cyclohexyl vinyl ether, tert-butyl vinyl ether, tert-amyl vinyl ether, diethylene glycol monovinyl ether, hexanediol monovinyl ether, aminopropyl vinyl ether, and 2-diethylaminoethyl vinyl ether.

In certain embodiments, in addition to the compound of formula (II), a divinyl ether of formula (III) may also be reacted with the dithiol of formula (I):

CH₂═CH—O—[—R²—O—]—CH═CH₂ (III)

Divinyl ether itself (m=0) can be used. Suitable divinyl ethers also include those compounds having at least one oxyalkylene group, such as from 1 to 4 oxyalkylene groups, i.e., those compounds in which m is an integer from 1 to 4, in some cases m is an integer from 2 to 4. It is also possible to employ commercially available divinyl ether mixtures in producing polythioethers according to the invention. Such mixtures are characterized by a non-integral average value for the number of alkoxy units per molecule. Thus, m in formula (III) can also take on non-integral, rational values between 0 and 10, such as between 1 and 10, in some cases between 1 and 4, in yet other cases between 2 and 4.

Exemplary divinyl ethers include, for example, those compounds in which R² in formula (III) is C₂₋₆ n-alkyene or C₂₋₆ branched alkyene. Suitable divinyl ethers of this type include, for example, ethylene glycol divinyl ether (EG-DVE) (R²=ethylene, m=1); butanediol divinyl ether (BD-DVE) (R²=butylene, m=1); hexanediol divinyl ether (HD-DVE) (R²=hexylene, m=1); diethylene glycol divinyl ether (DEG-DVE) (R=ethylene, m=2); triethylene glycol divinyl ether (R²=ethylene, m=3); and tetraethylene glycol divinyl ether (R²=ethylene, m=4). Useful divinyl ether blends include “PLURIOL®” type blends such as PLURIOL® E-200 divinyl ether (commercially available from BASF), for which R²=ethyl and m=3.8, as well as “DPE” polymeric blends such as DPE-2 and DPE-3 (commercially available from International Specialty Products, Wayne, N.J.).

Useful divinyl ethers in which R² in formula (III) is C₂₋₆ branched alkylene can be prepared by reacting a polyhydroxy compound with acetylene. Exemplary compounds of this type include compounds in which R² is an alkyl-substituted methylene group such as CH(CH₃)— or an alkyl-substituted ethylene such as CH₂CH(CH₃)—.

Other useful divinyl ethers include compounds in which R² in formula (III) is polytetrahydrofuryl (poly-THF) or polyoxyalkylene, such as those having an average of about 3 monomer units.

Two or more compounds of the formula (II) (and optionally formula (III)) can be used. Thus, in certain embodiments, two compounds of formula (I) and one compound of formula (II), one compound of formula (I) and two compounds of formula (II), two compounds of formula (I) and of formula (II), and more than two compounds of one or both formulas, can be used to produce a variety of polythioethers suitable for use in the present invention. As indicated, one or more compounds of formula (III) may also be used.

The reaction between the compounds of formulas (I) and (II) may be catalyzed by a free radical catalyst. Suitable free radical catalysts include azo compounds, for example azobisnitrile compounds such as azo(bis)isobutyronitrile (AIBN); organic peroxides such as benzoyl peroxide and t-butyl peroxide; and similar free-radical generators. The reaction can also be effected by irradiation with ultraviolet light either with or without a cationic photoinitiating moiety. Ionic catalysis methods, using either inorganic or organic bases, e.g., triethylamine, also yield materials useful in the present invention.

As will be appreciated from the foregoing description, in certain embodiments, the polythioether suitable for use in preparing the crosslinker of the present invention comprises a compound having the following structure (IV):

HS—R¹—[—S—(CH₂)₂—O—[—R²—O—]ₘ—(CH₂)₂—S—R¹—]ₙ—R⁴ (IV)

in which:

(a) each R¹ independently denotes a C₂₋₁₀ n-alkylene group, such as a C₂₋₆ n-alkylene group; a C₂₋₆ branched alkylene group, such as a C₃₋₆ branched alkylene group having one or more pendant groups which can be, for example, alkyl groups, such as methyl or ethyl groups; an alkyleneoxy group; a C₆₋₈ cycloalkylene group; a C₆₋₁₀ alkylcycloalkylene group; a heterocyclic group; or —[(—CHR³—)ₛ—X—]_{q}—(—CHR³—)ᵣ—, wherein s is an integer having a value ranging from 2 to 6, q is an integer having a value ranging from 1 to 5, r is an integer having a value ranging from 2 to 10, R³ is hydrogen or methyl, and X denotes O, S, or —NR₂—, wherein R denotes an alkyl group;

(b) each R² independently denotes methylene; a C₂₋₁₀ n-alkylene group, such as a C₂₋₆ n-alkylene group; a C₂₋₆ branched alkylene group, such as a C₃₋₆ branched alkylene group; a C₆₋₈ cycloalkylene group; a C₆₋₁₄ alkylcycloalkylene, such as a C₆₋₁₀ alkylcycloalkylene; a heterocyclic group, or —[(—CHR³—)ₛ—X—]_{q}—(—CHR³—)ᵣ—; wherein s, q, r, R³ and X are as defined above with respect to R¹;

(c) R⁴ is —SH or —SCH₂CH₂R, wherein R is as defined above with respect to formula (II);

(d) m is a rational number having a value ranging from 0 to 50, such as 0 to 10 or 1 to 10; and

(e) n is an integer having a value ranging from 0 to 60, such as 1 to 60.

In certain embodiments of the foregoing polythioether, when n is 0, R¹ is —[(—CHR³—)ₛ—X—]_{q}—(—CHR³—)ᵣ—, wherein s is 2, q is 2, r is 2, and X is O. Also, in certain embodiments of the foregoing polythioether, when n is 1, R² is —[(—CHR³—)ₛ—X—]_{q}—(—CHR³—)ᵣ—, wherein s is 2, q is 2, r is 2, and X is O.

Polythioethers suitable for use in the present invention may be prepared by combining at least one compound of formula (I) and at least one compound of formula (II), followed by addition of an appropriate catalyst, and carrying out the reaction at a temperature from 30 to 120° C., such as 70 to 90° C. for a time from 2 to 24 hours, such as from about 2 to about 6 hours. The Examples herein further illustrate suitable techniques for the preparation of such polythioethers.

Since the reaction is an addition reaction, rather than a condensation reaction, the reaction typically proceeds substantially to completion, i.e., yields of approximately 100% can be attained. In many cases, no or substantially no undesirable by-products are produced.

The crosslinking agents of the present invention can be prepared by any suitable technique. In certain embodiments, the aminoplast compound (a), and the aminoplast-reactive functional group-containing sulfur-containing compound (b) are combined in a suitably equipped reaction vessel, optionally with a suitable solvent and catalyst, such as a strong acid. Any suitable solvent can be used, but aromatic solvents are often employed. Non-limiting examples of suitable aromatic solvents include xylene, toluene, and mixtures thereof. Non-limiting examples of strong acids suitable for use as a catalyst include, but are not limited to, para-toluene sulfonic acid and dodecyl benzene sulfonic acid. Normal condensation techniques as are well-known in the art can be used.

The reaction admixture can be heated to a temperature ranging from 60° C. to 100° C., such as from 70° C. to 90° C., and held at that temperature for a period sufficient to obtain an ungelled product. The reaction is terminated when a pre-determined end point is detected by infrared spectroscopy or other suitable analytical technique.

In certain embodiments of the preparation of the crosslinking agent of the present invention, the aminoplast compound (a) and the aminoplast-reactive functional group-containing sulfur containing compound (b) are combined such that the equivalents of aminoplast compound (a) are in excess relative to the equivalents of the aminoplast-reactive functional group-containing sulfur-containing compound. This provides a stable crosslinking agent which is essentially free of functional groups that are reactive with the aminoplast compound. The reaction may be monitored for the disappearance of such functionality relative to an internal standard via infrared spectroscopy or other appropriate analytical technique (e.g., the thiol signal is compared to the signal of a structure which will remain essentially unchanged as the reaction proceeds to completion, for example, the C—H stretch signal). By “stable” crosslinking agent is meant that the crosslinking agent is essentially free of any functionalities that can be reactive with the aminoplast compound and no further reaction will occur when the composition is continuously heated at the designated temperatures; i.e., the crosslinking agent will not self-condense.

In certain embodiments, in the preparation of the crosslinking agent of the present invention, the ratio of moles of aminoplast compound (a) to the moles of the aminoplast-reactive functional group-containing sulfur-containing compound (b) ranges from 1.5 to 5.0:1, often from 1.8 to 4.0:1, and, in some cases, from 1.9 to 3.6:1. Additionally, when the aminoplast compound (a) comprises an (alkoxyalkyl)aminotriazine, it should be understood that the theoretical molecular weight of the monomeric aminotriazine (that is, where DP=1) is used to calculate the “molar ratio”.

The present invention is also directed to curable coating compositions comprising a film-forming mixture of (A) a polymer having functional groups reactive with aminoplast groups and (B) the crosslinking agent described above. The coating compositions of the present invention may be in liquid form or in the form of solid particulates, i.e., powder coating compositions.

As mentioned, the curable coating compositions of the present invention comprise, as a first component (A), at least one aminoplast-reactive functional group-containing polymer and, as a second component (B), the crosslinking agent described above. The components (A) and (B) of the curable coating composition may each independently comprise one or more functional species, and are each present in amounts sufficient to provide cured coatings having a desirable combination of physical properties, e.g., smoothness, optical clarity, scratch resistance, solvent resistance and/or hardness.

As used herein, the term “cure” as used in connection with a composition, e.g., “a curable composition,” shall mean that any crosslinkable components of the composition are at least partially crosslinked. In certain embodiments of the present invention, the crosslink density of the crosslinkable components, i.e., the degree of crosslinking, ranges from 5% to 100% of complete crosslinking. In other embodiments, the crosslink density ranges from 35% to 85% of full crosslinking. In other embodiments, the crosslink density ranges from 50% to 85% of full crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen. This method determines the glass transition temperature and crosslink density of free films of coatings or polymers. These physical properties of a cured material are related to the structure of the crosslinked network.

According to this method, the length, width, and thickness of a sample to be analyzed are first measured, the sample is tightly mounted to the Polymer Laboratories MK III apparatus, and the dimensional measurements are entered into the apparatus. A thermal scan is run at a heating rate of 3° C./min, a frequency of 1 Hz, a strain of 120%, and a static force of 0.01N, and sample measurements occur every two seconds. The mode of deformation, glass transition temperature, and crosslink density of the sample can be determined according to this method. Higher crosslink density values indicate a higher degree of crosslinking in the coating.

Also, as used herein, the term “polymer” is meant to refer to oligomers and both homopolymers and copolymers. Unless stated otherwise, if used herein, molecular weights are number average molecular weights for polymeric materials indicated as “Mn” and obtained by gel permeation chromatography using a polystyrene standard in an art-recognized manner.

The polymer (A) can be any of a variety of polymers having aminoplast-reactive functional groups as are well known in the art. Non-limiting examples of polymers having aminoplast-reactive functional groups useful in the curable coating compositions of the invention include those selected from acrylic, polyester, polyurethane, polyepoxide and polyether polymers. The polymer (A) can comprise a wide variety of functional groups, for example, hydroxyl, carboxyl, anhydride, epoxy, thio, phenolic, amine and/or amide functional groups. In certain embodiments, the polymer (A) comprises an aminoplast-reactive functional group selected the group consisting of hydroxyl, epoxy, carboxyl and/or carbamate functional groups.

In certain embodiments of the present invention, the polymer (A) comprises hydroxyl and/or carbamate functional groups. For example, hydroxyl and/or carbamate functional group-containing acrylic polymers and/or polyester polymers are suitable for use as the polymer (A). In other embodiments of the invention, the polymer (A) comprises epoxy and/or hydroxyl functional groups.

Suitable functional group-containing acrylic polymers, polyester polymers, polyurethane polymers, and polyether polymers, as well as methods for their preparation, include, for example, those described in U.S. Pat. No. 6,613,436 at col. 13, line 32 to col. 18, line 6, the cited portion of which being incorporated herein by reference.

It should be understood that the carbamate functional group-containing polymers can contain residual hydroxyl functional groups which provide additional crosslinking sites. The carbamate/hydroxyl functional group-containing polymer (A) can have a residual hydroxyl value ranging from 0.5 to 10, such as from 1 to 10, or, in some cases, from 2 to 10 (mg KOH per gram).

The functional group-containing polymer (A) can be present in the curable coating compositions of the present invention in an amount ranging from at least 5 percent by weight, usually at least 20 percent by weight, often at least 30 percent by weight, and sometimes at least 40 percent by weight based on the total weight of the film-forming composition. The functional group-containing polymer (A) also can be present in the curable coating compositions of the present invention in an amount less than 95 percent by weight, usually less than 90 percent by weight, often less than 80 percent by weight, and sometimes less than 75 percent by weight based on the total weight of the curable coating composition. The amount of the functional group-containing polymer (A) present in the coating compositions of the present invention can range between any combination of these values inclusive of the recited values.

As mentioned above, the curable coating compositions of the present invention further comprise, as component (B), the crosslinking agent described above. The crosslinking agent (B) can be present in the curable coating compositions of the present invention in an amount ranging from at least 5 percent by weight, usually at least 10 percent by weight, often at least 20 percent by weight, and sometimes at least 25 percent by weight based on the total weight of the coating composition. The crosslinking agent (B) also can be present in the curable coating compositions of the present invention in an amount less than 95 percent by weight, usually less than 80 percent by weight, often less than 70 percent by weight, and sometimes less than 60 percent by weight based on the total weight of the coating composition. The amount of the crosslinking agent (B) present in the curable coating compositions of the present invention can range between any combination of these values inclusive of the recited values.

If desired, the curable coating compositions of the present invention also can include an adjuvant curing agent which is different from the crosslinking agent (B). The adjuvant curing agent can be any compound having functional groups reactive with the functional groups of the polymer (A) and/or the crosslinking agent (B) described above. Non-limiting examples of suitable adjuvant curing agents include, for example, blocked isocyanates, triazine compounds, glycoluril resins, and mixtures thereof. Suitable blocked isocyanate, aminoplast, glycoluril and triazine crosslinkers include, for example, those described in U.S. Pat. No. 6,613,436 at col. 18, line 58 to col. 19, line 35, the cited portion of which being incorporated herein by reference.

In certain embodiments, the adjuvant curing agent comprises a blocked polyisocyanate curing agent comprising a tricarbamoyl triazine compound having the formula C₃N₃(NHCOXR)₃, wherein X is nitrogen, oxygen, sulfur, phosphorus, or carbon, in some cases oxygen, and R is a lower alkyl group having 1 to 12 carbon atoms, or a mixture of lower alkyl groups having 1 to 12 carbon atoms. In certain embodiments, R has 1 to 8 carbon atoms, for example, methyl, ethyl, n-propyl, i-propyl, butyl, n-octyl, 2-ethylhexyl. In certain embodiments, R is a mixture of methyl and butyl groups. Such compounds and the preparation thereof are described in detail in U.S. Pat. No. 5,084,541, which is incorporated herein by reference.

When employed, the adjuvant curing agent typically is present in the curable coating compositions of the present invention in an amount ranging from 0.5 to 20 percent by weight, such as from 1 to 15 percent by weight based on the total weight of the curable coating composition. Mixtures of the above-described adjuvant curing agents also can be used.

Also, it should be understood that for purposes of the present invention, the curable coating compositions which contain epoxy group-containing polymers typically also include an epoxide-reactive curing (i.e., crosslinking) agent, usually an acid functional curing agent, in addition to the crosslinking agent (B). A secondary hydroxyl group can be generated upon reaction of each epoxy functional group with a functional group of the epoxide-reactive curing agent. These secondary hydroxyl groups are then available for subsequent reaction with the aminoplast-based crosslinking agent (B) and/or any adjuvant curing agents if employed.

Epoxide-reactive curing agents which can be used in curable coating compositions of the present invention comprising an epoxide functional polymer can have functional groups selected from the group consisting of hydroxyl, thiol, primary amines, secondary amines, acid (e.g. carboxylic acid) and mixtures thereof. Useful epoxide reactive curing agents having amine functionality include, for example, dicyandiamide and substituted dicyandiamides. In certain embodiments, the epoxide reactive curing agent has carboxylic acid groups.

As used herein, the term “epoxide reactive crosslinking agent” means that the epoxide reactive crosslinking agent has at least two functional groups that are reactive with epoxide functionality. In certain embodiments, the epoxide reactive crosslinking agent is a carboxylic acid functional curing agent, which contains from 4 to 20 carbon atoms. Examples of carboxylic acid functional crosslinking agents useful in the present invention include, but are not limited to, dodecanedioic acid, azelaic acid, adipic acid, 1,6-hexanedioic acid, succinic acid, pimelic acid, sebasic acid, maleic acid, citric acid, itaconic acid, aconitic acid and mixtures thereof.

Other suitable carboxylic acid functional curing agents, and methods for their preparation, include, without limitation, those described in U.S. Pat. No. 6,613,436 at col. 20, lines 14-52, the cited portion of which being incorporated herein by reference.

Curable coating compositions comprising epoxide functional polymers and epoxide reactive curing agents sometimes contain both in a total amount ranging from 50 percent to 99 percent by weight based on total weight of the composition, e.g., from 70 percent to 85 percent by weight, based on total weight of the composition. The epoxide reactive curing agent sometimes is present in the curable coating composition in an amount corresponding to a portion of these recited ranges, i.e., 5 to 40, particularly 15 to 30, percent by weight based on the total weight of the composition. The equivalent ratio of epoxide equivalents in the epoxide functional polymer to the equivalents of reactive functional groups in the curing agent is sometimes from 0.5:1 to 2:1, e.g., from 0.8:1 to 1.5:1.

Curable coating compositions of the present invention comprising an epoxide functional polymer as reactant (A) and an epoxide reactive curing agent sometimes contain the crosslinking agent (B) in an amount ranging from 1 to 50 weight percent, typically from 15 to 30 weight percent based on total weight of the coating composition.

To promote curing of the compositions of the invention, the compositions may optionally contain a curing catalyst to facilitate curing of the functional groups of polymer (A) with crosslinking agent (B). Non-limiting examples of suitable catalysts for use in the compositions of the present invention are acidic materials, such as acid phosphates, such as aryl acid phosphates, including phenyl acid phosphate; sulfonic acids, such as para-toluene sulfonic acid and dodecyl benzene sulfuric acid, as well as tin compounds such as dialkyl tin compounds such as dibutyltin dilaurate and dibutyltin oxide.

In the case where an epoxide functional polymer and an epoxide reactive curing agent is present in the compositions of the present invention, such compositions may also include one or more cure catalysts as are known in the art for catalyzing the reaction between the reactive functional groups of the crosslinking agent and the epoxide groups of the polymer. Examples of cure catalysts for use with acid functional crosslinking agents include tertiary amines, e.g., methyl dicocoamine and tin compounds, e.g., triphenyl tin hydroxide.

The cure catalyst, when used, is present in an amount sufficient to accelerate the reaction between the functional groups of polymer (A) with the crosslinking agent (B). In certain embodiments, the amount of catalyst present in the composition is from 0.01 to 5 percent by weight based on weight of resin solids.

The curable coating compositions of the present invention can further include additives as are commonly known in the art, such as surfactants, wetting agents, and colorants, among others. Typical additives include benzoin, used to reduce entrapped air or volatiles; flow aids or flow control agents which aid in the formation of a smooth and/or glossy surface, for example, MODAFLOW® available from Monsanto Chemical Co., waxes such as MICROWAX® C available from Hoechst, and fillers such as calcium carbonate, barium sulfate and the like.

As used herein, the term “colorant” means any substance that imparts color and/or other opacity and/or other visual effect to the composition. The colorant can be added to the composition in any suitable form, such as discrete particles, dispersions, solutions and/or flakes. A single colorant or a mixture of two or more colorants can be used.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In certain embodiments, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain embodiments, a photosensitive composition and/or photochromic composition, which reversibly alters its color when exposed to one or more light sources, can be used. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In certain embodiments, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In certain embodiments, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with certain embodiments of the present invention, have minimal migration out of the coating. Example photosensitive compositions and/or photochromic compositions and methods for making them are identified in U.S. application Ser. No. 10/892,919 filed Jul. 16, 2004, incorporated herein by reference.

In general, the colorant can be present in the coating composition in any amount sufficient to impart the desired visual and/or color effect. The colorant may comprise from 1 to 65 weight percent, such as from 3 to 40 weight percent or 5 to 35 weight percent, with weight percent based on the total weight of the composition.

The curable coating compositions of the invention can be prepared by a variety of methods, such as, for example, the methods illustrated in the Examples herein.

The curable coating compositions of the invention can be applied to a variety of substrates including metallic substrates, for example, aluminum and steel substrates, and non-metallic substrates, for example, thermoplastic or thermoset composite substrates. The curable coating compositions of the present invention can be applied to the substrate by any of a variety of methods known to those skilled in the art, such as dipping or immersion, spraying, intermittent spraying, dipping followed by spraying, spraying followed by dipping, brushing, or roll-coating. The coating can be applied to provide a film having a thickness after cure of from 1 to 10 mils (25 to 250 micrometers), sometimes 2 to 4 mils (50 to 100 micrometers).

In certain embodiments, after application of the coating composition, the coated substrate is heated to a temperature sufficient to cure the coating, such as to a temperature ranging from 250° F. to 500° F. (121.1° C. to 260.0° C.) for 1 to 60 minutes, and, in some cases, from 300° F. to 400° F. (148.9° C. to 204.4° C.) for 15 to 30 minutes.

The coating compositions of the present invention can be applied as a primer or primer surfacer, or as a topcoat, for example, a “monocoat”. The curable coating composition of the invention also can be advantageously employed as a topcoat in a multi-component composite coating composition. Such a multi-component composite coating composition generally comprises a base coat deposited from a film-forming composition and a topcoat applied over the base coat, the topcoat being deposited from a coating composition of the present invention as described above. In certain embodiments, the multi-component composite coating composition is a color-plus-clear system where the basecoat is deposited from a pigmented film-forming coating composition and the topcoat is deposited from a coating composition which is substantially pigment-free, i.e., a clear coat. In certain embodiments, a coating composition of the present invention is used to deposit one or more of the coating layers deposited in the processes disclosed in United States Patent Application Publication No. 2004-0159555 and/or U.S. patent application Ser. No. 11/845,324, both of which being incorporated herein by reference. In certain embodiments, a coating composition of the present invention is used to deposit one or more of the coating layers deposited in a “wet-on-wet” coating process wherein two or more, sometimes three coating layers (such as primer, basecoat, and clearcoat), are deposited, and then all the coating layers are cured simultaneously.

The film-forming composition from which the base coat is deposited can be any of the compositions useful in coatings applications for example, in automotive applications where color-plus-clear systems are most often used. A film-forming composition conventionally comprises a resinous binder and a colorant. Particularly useful resinous binders include acrylic polymers, polyesters including alkyds, and polyurethanes.

The resinous binders for the base coat can be organic solvent-based materials, such as those described in U.S. Pat. No. 4,220,679. Water-based coating compositions, such as those described in U.S. Pat. Nos. 4,403,003; 4,147,679; and 5,071,904, also can be used as the base coat composition.

The base coat film-forming compositions are typically applied to the substrate such that a cured base coat having a film thickness ranging from 0.5 to 4 mils (12.5 to 100 micrometers) is formed thereon.

After forming a film of the base coat on the substrate, the base coat can be cured or alternatively given a drying step in which solvent, i.e., organic solvent and/or water, is driven off by heating or an air drying step before application of the clear coat. Suitable drying conditions will depend on the particular base coat film-forming composition and on the ambient humidity with certain water-based compositions. In general, a drying time ranging from 1 to 15 minutes at a temperature of 75° F. to 200° F. (21° C. to 93° C.) is adequate.

Illustrating the invention are the following examples which are not to be considered as limiting the invention to their details. Unless otherwise indicated, all parts and percentages in the following examples, as well as throughout the specification, are by weight.

### EXAMPLES

### Example 1

To a reaction flask equipped with a mechanical stirrer, temperature probe and refluxing condenser was added 186.02 grams of 3,6-dioxa-1,8-octanedithiol and 102.2 grams of butyl vinyl ether. The resulting mixture was warmed to 65° C. and 0.145 grams of VAZO 67 (commercially available from DuPont Chemicals) was added in three approximately equal portions over 6 hours. The measured SH equivalent weight was 252. The reaction was heated to 80° C., 0.0486 grams VAZO 67 added and the reaction held at 80° C. for 2 hours. The reaction was cooled and resulting material measured 84.5% solids (1 hour, at 110° C.) and SH equivalent weight of 254.

### Example 2

To a reaction flask equipped with mechanical stirrer, temperature probe and refluxing condenser was added 242.5 grams of CYMEL 303 (commercially available from Cytec Industries), 127.0 grams of the product of Example 1 and 480 grams of methanol. The resulting mix was stirred for 10 minutes and 1.14 grams of p-toluene sulfonic acid was added. The reaction was warmed to reflux (67-70° C.) for 1.5 hours then cooled. The SH measured equivalent weight was 149169. To the resulting mixture was added 2.74 grams of sodium bicarbonate, and the methanol removed by vacuum distillation. The resulting light yellow oil was filtered and measured 97.1% solids (1 hour at 100° C.).

### Example 3

To a reaction flask equipped with mechanical stirrer, temperature probe and refluxing condenser was added 242.5 grams of CYMEL 202 (commercially available from Cytec Industries), 89.2 grams of the product of Example 1 and 480 grams of methanol. The resulting mix was stirred for 10 minutes and 1.14 grams of p-toluene sulfonic acid was added. The reaction was warmed to reflux (67-70° C.) for 3.5 hours then cooled. The measured SH equivalent weight was 20148. To the resulting mixture was added 2.73 grams of sodium bicarbonate and the methanol was removed by vacuum distillation. Acetone was added to the mixture and the solution was filtered. Removal of the acetone by vacuum distillation resulted in a light yellow oil which measured 86.4% solids.

### Example 4

To a reaction flask equipped with a mechanical stirrer, temperature probe and refluxing condenser was added 139.52 grams of 3,6-dioxa-1,8-octanedithiol and 102.2 grams of butyl vinyl ether. The resulting mixture was warmed to 60° C. and held at temperature for 1 hour. Then, the temperature was increased to 80° C. and 0.192 grams of VAZO 67 was added in four approximately equal portions over 8 hours. The reaction was cooled and resulting material measured 89.7% solids (1 hour, at 110° C.) and SH equivalent weight of 254.

### Example 5

To a reaction flask equipped with mechanical stirrer, temperature probe and refluxing condenser was added 121.4 grams of CYMEL 202, 118.62 grams of the product of Example 4 and 241 grams of methanol. The resulting mix was stirred for 10 minutes and 0.51 grams of p-toluene sulfonic acid was added. The reaction was warmed to reflux (67 to 70° C.) for 3.5 hours then cooled. The measured SH equivalent weight was 12386. To the resulting mixture was added 1.38 grams of sodium bicarbonate, and the methanol removed by vacuum distillation. The resulting light yellow oil was filtered and measured 70.2% solids (1 hour at 100° C.).

### Example 6

To a reaction flask equipped with mechanical stirrer, temperature probe and refluxing condenser was added 122.32 grams of CYMEL 303, 114.23 grams of the product of Example 4 and 239 grams of methanol. The resulting mix was stirred for 10 minutes and 0.58 grams of p-toluene sulfonic acid was added. The reaction was warmed to reflux (67 to 70° C.) for 4.0 hours then cooled. The measured SH equivalent weight was 60167. To the resulting mixture was added 1.38 grams of sodium bicarbonate, and the methanol removed by vacuum distillation. The resulting light yellow oil was filtered and measured 97.3% solids (1 hour at 100° C.).

### Example 7

### Preparation of Film Forming Compositions

Composition pre-mixtures were prepared using the ingredients and amounts identified in Table 1. Each ingredient was mixed sequentially with agitation.

TABLE 1

| | Parts by weight | Solid weights |
|---|---|---|
| Ingredient | (grams) | (grams) |
| Methyl n-amyl ketone | 9.26 | — |
| Xylene | 1.29 | — |
| Aromatic Solvent - 100 Type | 4.78 | — |
| Butyl Cellosolve ® acetate¹ | 0 | — |
| Hexyl Cellosolve ®² | 0.63 | — |
| EVERSORB 76³ | 1.49 | 1.49 |
| CHIGUARD ® 328⁴ | 1.49 | 1.49 |
| Anti-sag Solution⁵ | 16.88 | 6.96 |
| Acrylic polyol⁶ | 72.44 | 48.75 |
| Ethanol | 5.48 | — |
| Polybutyl acrylate⁷ | 0.69 | 0.411 |
| Multiflow⁸ | 0.466 | 0.233 |
| Acid Catalyst/HALS Solution⁹ | 1.92 | 1.02 |

¹2-Butoxy ethanol acetate solvent is commercially available from Dow Chemical Company.
²Solvent available from Dow Chemical Company.
³Benzotriazole derivative available from Everlight Chemical Industrial Corporation.
⁴Substituted benzotriazole available from CHITEC Technology Corporation.
⁵A dispersion containing AEROSIL R812 silica (available from Degussa), and a polymeric component which comprises hydroxy propyl acrylate, styrene, butyl methacrylate, butyl methacrylate acrylic acid.
⁶Acrylic polyol formed from hydroxy propyl acrylate, styrene, butyl methacrylate, butyl methacrylate acrylic acid.
⁷A flow control agent having a Mw of about 6700 and a Mn of about 2600 made in xylene at 62.5% solids available from DuPont.
⁸50% solution of MODAFLOW ®, available from Cytec Industries, Inc., supplied in xylene. MODAFLOW ® is a polymer made of 75% by weight 2-ethyl hexyl acrylate, 25% by weight ethyl acrylate with a number average molecular weight of about 7934.
⁹Solution of dodecyl benzene sulfonic acid solution, available from Chemcentral, and EVERSORB 93, a hindered amine light stabilizer available from Everlight Chemical Industrial Corporation.

Film-forming compositions were prepared using the ingredients and amounts identified in Table 2. Each ingredient was mixed sequentially with agitation.

TABLE 2

| Ingredient | Ex. 7A | Ex. 7B | Ex. 7C | Ex. 7D | Ex. 7E | Ex. 7F |
|---|---|---|---|---|---|---|
| Example 7 Pre-mix | 116.81 | 116.81 | 116.81 | 116.81 | 116.81 | 116.81 |
| | (60.35) | (60.35) | (60.35) | (60.35) | (60.35) | (60.35) |
| CYMEL 303¹ | 45.60 | — | — | — | — | — |
| | (45.60) | | | | | |
| Product of Example 6 | — | 46.87 | — | — | — | — |
| | | (45.60) | | | | |
| Product of Example 2 | — | — | 47.01 | — | — | — |
| | | | (45.60) | | | |
| CYMEL 202² | — | — | — | 57.00 | — | — |
| | | | | (45.60) | | |
| Product of Example 5 | — | — | — | — | 65.14 | — |
| | | | | | (45.60) | |
| Product of Example 3 | — | — | — | — | — | 52.78 |
| | | | | | | (45.60) |
| Methyl n-amyl ketone | 8.00 | — | — | — | — | — |
| Butyl Cellosolve ® acetate³ | 2.00 | — | — | — | — | — |
| Reduction Information: | | | | | | |
| Methyl n-amyl ketone | 0.0 | 8.0 | 24.0 | 40.0 | 0.0 | 32.0 |
| Butyl Cellosolve ® acetate³ | 0.0 | 2.0 | 6.0 | 10.0 | 0.0 | 8.0 |
| Spray viscosity⁴ (sec) | 32 | 31 | 28 | 31 | 24 | 31 |
| Paint temperature (° F.) | 73 | 73 | 72 | 73 | 72 | 73 |
| Calculated % Solids⁵ | 62 | 63 | 59 | 53 | 58 | 56 |

¹Hexamethoxymethylmelamine resin available from Cytec Industries, Inc.
²High imino melamine resin available from Cytec Industries, Inc.
³2-Butoxyethyl acetate solvent commercially available from Union Carbide Corp.
⁴Viscosity measured in seconds with a #4 FORD efflux cup at ambient temperature.
⁵Calculated % Solids of a coating is determined by taking the solid weight of a specific quantity of the coating and dividing it by the solution weight.

### Testing

The film forming compositions of Examples 7A-7F were spray applied to a pigmented basecoat to form color-plus-clear composite coatings over electrocoated steel panels. The panels used were cold rolled steel panels (size 4 inches×12 inches (10.16 cm by 30.48 cm)) coated with ED6060 electrocoat available from PPG Industries, Inc. The test panels are available as APR40237 from ACT Laboratories, Inc. of Hillsdale, Mich. The basecoat used was Sleek Silver, silver pigmented water-based acrylic/melamine basecoat, available from PPG Industries, Inc.

Basecoats were automated spray applied to the electrocoated steel panels at ambient temperature (about 70° F. (21° C.)). A dry film thickness of about 0.55 to 0.65 (about 14 to 17 micrometers) was targeted for the basecoat. After the basecoat application, an air flash at ambient temperature was given before force flashing the water-based basecoated panels for 3 minutes at 180° F. (82° C.).

The clear coating compositions of Examples 7A-7F were each automated spray applied to a basecoated panel at ambient temperature in two coats with an ambient flash between applications. Clearcoats were targeted for a 1.7 to 1.9 mils (about 43 to 48 micrometers) dry film thickness. The clear coatings were allowed to air flash at ambient temperature before the oven. Panels prepared from each coating were baked for thirty minutes at 285° F. (141° C.) to cure the coating(s). For each clear coating, one panel was baked in a horizontal position and a second panel was baked in a vertical position.

Properties for the coatings baked horizontally are reported below in Table 3 and data for panels baked vertically are listed in Table 4.

TABLE 3

| Example # | 20° Gloss¹ | DOI² | CF³ | Acid Etch Resistance⁴ |
|---|---|---|---|---|
| 7A | 96 | 85 | 46 | 10 |
| 7B | 96 | 85 | 53 | 8 |
| 7C | 96 | 90 | 53 | 9 |
| 7D | 96 | 79 | 48 | 10 |
| 7E | 85 | 81 | 46 | 8 |
| 7F | 97 | 77 | 44 | 7 |

¹20° gloss was measured with a Statistical Novo-Gloss 20° gloss meter, available from Paul N. Gardner Company, Inc.
²Distinctness-of image (DOI) measurement was measured with a Tricor System DOI/Haze meter, Model 807A.
³The Combined Factor (CF) was calculated using the appearance measurements from the Wave-scan DOI meter, available from Byk-Gardner, using the following equation: 15% Luster + 35% Sharpness + 50% Orange Peel. Higher values indicate better appearance.
⁴A solution of sulfuric acid (0.2N available from Fisher Scientific) and deionized water is applied in the form of two rows of droplets using a Costar 50 microliter octapette (available from Fisher Scientific) onto coated test panels. The panels are then placed in an oven at a 120° F. (49° C.) for 20 minutes. The panels are then removed from the oven,and the procedure is repeated one to two times, so as to give a total bake time of one hour. With each cycle, the new drops of solution are placed directly on the spots from the previous cycle. After the final cycle, the panels are washed with soap and water, and then dried. The acid etch resistance is rated on a scale of 0 to 10, with 0 = no visible etching and 10 = severe etching.

TABLE 4

| Example # | 20° Gloss¹ | DOI² | CF³ |
|---|---|---|---|
| 7A | 95 | 77 | 39 |
| 7B | 94 | 79 | 49 |
| 7C | 97 | 80 | 46 |
| 7D | 90 | 28 | 25 |
| 7E | 85 | 58 | 37 |
| 7F | 96 | 57 | 32 |

¹20° gloss was measured with a Statistical Novo-Gloss 20° gloss meter, available from Paul N. Gardner Company, Inc.
²Distinctness-of-image (DOI) measurement was measured with a Tricor System DOI/Haze meter, Model 807A.
³The Combined Factor (CF) was calculated using the appearance measurements from the Wave-scan DOI meter, available from Byk-Gardner, using the following equation: 15% Luster + 35% Sharpness + 50% Orange Peel. Higher values indicate better appearance.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A crosslinking agent comprising an ungelled reaction product of reactants comprising:
(a) an aminoplast compound; and
(b) an aminoplast-reactive functional group-containing sulfur-containing compound.

2. The crosslinking agent of claim 1, wherein the aminoplast compound is derived from at least one of glycoluril, aminotriazine and benzoguanamine.

3. The crosslinking agent of claim 1, wherein the aminoplast-reactive functional group-containing sulfur-containing compound comprises hydroxyl, carboxyl, anhydride, epoxy, thiol, phenolic, amine and/or amide functional groups.

4. The crosslinking agent of claim 1, wherein the aminoplast-reactive functional group-containing sulfur-containing compound comprises a thiol, a polythiol, a thioether, a polythioether, and/or a polysulfide.

5. The crosslinking agent of claim 1, wherein the aminoplast-reactive functional group-containing sulfur-containing compound comprises an aminoplast reactive-functional group-containing thioether.

6. The crosslinking agent of claim 5, wherein the aminoplast-reactive functional group-containing thioether comprises a thiol functional polythioether.

7. The crosslinking agent of claim 6, wherein the thiol functional polythioether comprises a polythiol polythioether.

8. The crosslinking agent of claim 4, wherein the polythioether comprises a compound having the structure:
HS—R¹—[—S—(CH₂)₂—O—[—R²—O—]ₘ—(CH₂)₂—S—R¹—]ₙ—R⁴
in which:
(a) each R¹ independently denotes a C₂₋₁₀ n-alkylene group; a C₂₋₆ branched alkylene group; an alkyleneoxy group; a C₆₋₈ cycloalkylene group; a C₆₋₁₀ alkylcycloalkylene group; a heterocyclic group; or —[(—CHR³—)ₛ—X—]_{q}—(—CHR³—)ᵣ—, wherein S is an integer having a value ranging from 2 to 6, q is an integer having a value ranging from 1 to 5, r is an integer having a value ranging from 2 to 10, R³ is hydrogen or methyl, and X denotes O, S, or —NR₂—, wherein R denotes an alkyl group;
(b) each R² independently denotes methylene; a C₂₋₁₀ n-alkylene group; a C₂₋₆ branched alkylene group; a C₆₋₈ cycloalkylene group; a C₆₋₁₄ alkylcycloalkylene; a heterocyclic group; or —[(—CHR³—)ₛ—X—]_{q}—(—CHR³—)ᵣ—; wherein s, q, r, R³ and X are as defined above with respect to R¹;
(c) R⁴ is —SH or —SCH₂CH₂R, wherein R is a divalent hydrocarbon radical having from 2 to 20 carbon atoms that does not include any functional groups reactive with —SH;
(d) m is a rational number having a value ranging from 0 to 50; and
(e) n is an integer having a value ranging from 0 to 60.

9. The crosslinking agent of claim 8, wherein n is 0 and R¹ is —[(—CHR³)ₛ—X—]_{q}—(—CHR³—)ᵣ—, wherein s is 2, q is 2, r is 2, and X is O.

10. The crosslinking agent of claim 8, wherein n is 1 and R² is —[(—CHR³)ₛ—X—]_{q}—(CHR³—)ᵣ—, wherein s is 2, q is 2, r is 2, and X is O.

11. The crosslinking agent of claim 1, wherein the ratio of moles of aminoplast compound (a) to the moles of the aminoplast-reactive functional group-containing sulfur-containing compound (b) ranges from 1.5 to 5.0:1.

12. A curable coating composition comprising a film-forming mixture of:
(A) a polymer having functional groups reactive with aminoplast groups and
(B) the crosslinking agent of claim 1.

13. The curable coating composition of claim 12, wherein the polymer having functional groups reactive with aminoplast groups comprises a hydroxyl and/or an epoxide functional acrylic polymer.

14. The curable coating composition of claim 12, wherein the polymer (A) is an acrylic, polyester, polyurethane, polyepoxide and/or polyether polymer.

15. The curable coating composition of claim 12, wherein the polymer (A) comprises hydroxyl, carboxyl, carbamate, anhydride, epoxy, thio, phenolic, amine and/or amide functional groups.

16. The curable coating composition of claim 12, further comprising an adjuvant curing agent which is different from the crosslinking agent (B).

17. A substrate at least partially coated with a coating deposited from the coating composition of claim 12.

18. A multi-component composite coating composition comprising the coating composition of claim 12.
